(19) United States
(12) Patent Application Publication
(10) Pub. No.: US 2004/0021642 A1
(43) Pub. Date: Feb. 5, 2004

(54) Wireless digital tablet with multiple transmission modes

(76) Inventor: Ting-Shan Cheng, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/207,243

(22) Filed: Jul. 30, 2002

(51) Int. Cl. G09G 5/00

(52) U.S. Cl. 345/173

(57) ABSTRACT

The present invention provides a wireless digital tablet with multiple transmission modes comprising a position detect unit, a transmission control unit, at least one wired connector, a wireless transmitter module, a wireless receiver module, a coder, and a decoder so that the wireless digital tablet transmit data to a computer at wired or wireless mode automatically according to whether the wired connector is connected in order to provide the selectivity of multiple transmission modes and save the consumption of the battery power of the wireless digital tablet.

### BACKGROUND OF THE INVENTION

1. Field of the Invention

The present invention relates to a wireless digital tablet with multiple transmission modes, particularly to a wireless digital tablet comprising at least one wired connector, such that the wireless digital tablet changes to a wired or wireless transmission mode automatically according to whether a wired connector is connected, and as a result provides the selectivity of multiple transmission modes and save the consumption of the battery power of the wireless digital tablet.

2. Description of the Prior Art

Digital tablets with handwriting input are well known. Whereas the manner the well-known digital tablets transmit data is either by wirelessly connecting to a computer or through a wire. Wireless digital tablets are more convenient in use than wired ones, but without a power line they have to use a battery to drive their circuits. It is therefore an important subject to save the battery consumption in wireless digital tablets.

Accordingly, a wireless digital tablet with both wired and wireless transmission modes contents both the need of wireless transmission mode where the user is limited to wire and space and the need of wired transmission mode to save the consumption of the battery power of the wireless digital tablet by being powered by the computer.

### SUMMARY OF THE INVENTION

According to the background of the present invention described above, the object of the present invention is to provide a wireless digital tablet with multiple transmission modes, so as to connect to a computer at a wired or wirelessly mode.

Another object of the present invention is to provide a wireless digital tablet with multiple transmission modes, such that when the wireless digital tablet connects with the computer at a wired mode, the computer powers the wireless digital tablet so as to save the consumption of the battery power of the wireless digital tablet.

To achieve the objects described above, the present invention provides a wireless digital tablet with multiple transmission modes comprising a position detect unit, a transmission control unit, at least one wired connector, a wireless transmitter module, a wireless receiver module, a coder and a decoder so that the wireless tablet transmits data to a computer at a wired or wireless mode automatically according to whether the wired connector is connected in order to provide the selectivity of multiple transmission modes and save the consumption of the battery power of the wireless digital tablet.

### BRIEF DESCRIPTION OF THE DRAWINGS

FIG. 1 shows the circuit block diagram of the wireless digital tablet with multiple transmission modes provided in the present invention;

FIG. 2 shows the flow chart for the detect loop of the transmission control unit;

FIG. 3 shows the position-relative data signal before coding;

FIG. 4 shows how the position-relative data signal coded by the coder; and

FIG. 5 depicts the concrete structure of a preferred embodiment.

### DESCRIPTION OF THE PREFERRED EMBODIMENT

The preferred embodiments of the present invention will be described detailed as follows. Whereas, the present invention may be practiced extensively otherwise than the described herein, and as a result the present invention is not limited to the exact construction and operation illustrated and described herein and the scope of the present invention is within that of the claims hereafter.

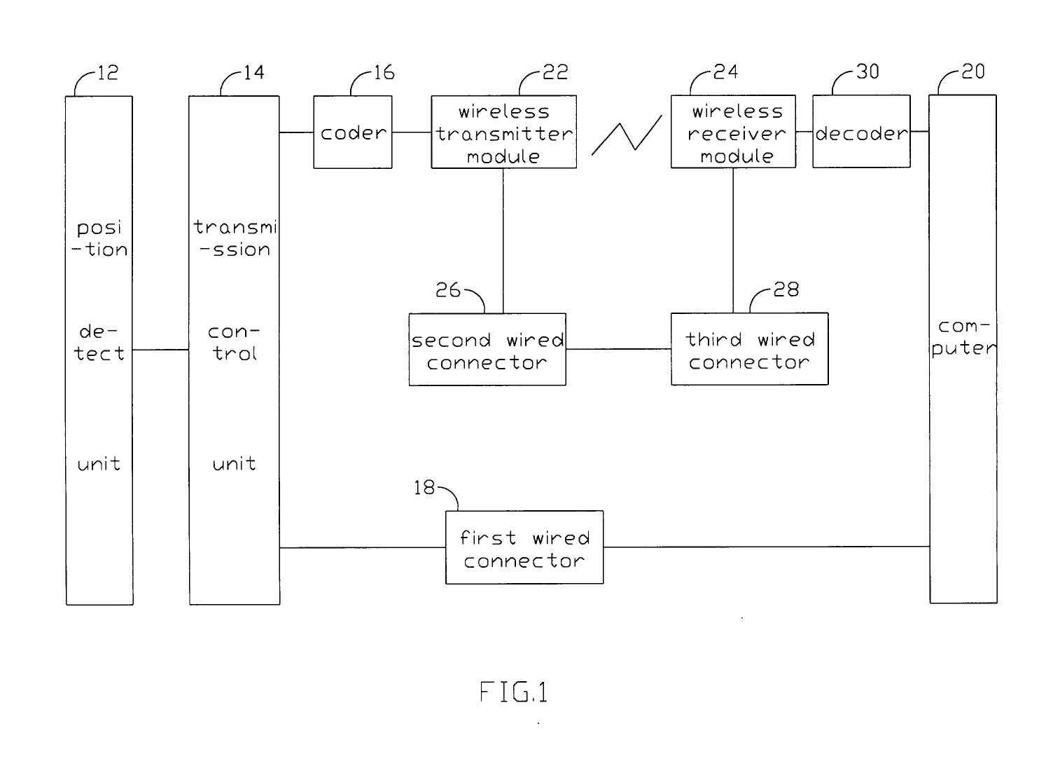

FIG. 1 shows the circuit block diagram of the wireless digital tablet with multiple transmission modes provided in the present invention, wherein the position detect unit 12 is used to detect the position of the induction pen, not shown, and produce a data signal relative to the position. The position detect unit 12 comprises an antenna loop, a transform circuit, and a process circuit. While the induction pen, not shown, is moving upon the digital tablet, the antenna loop of the position detect unit 12 induces an induced signal which is transformed to the corresponding digital signal by the transform circuit, whereby the process circuit processes the digital signal to obtain the position of the induction pen, and transmits the position-relative data signal to the transmission control unit 14 shown in FIG. 1. The position-relative data signal comprises an X-coordinate data signal, which is the position in X coordinate of the induction pen; a Y-coordinate data signal, which is the position in Y coordinate of the induction pen; a pressure signal, which indicates the pressure from the tip of the induction pen; and a button signal which indicates the status of the buttons on the induction pen.

As shown in FIG. 1, the transmission control unit 14 connects with a coder 16 and a first wired connector 18 in addition to the position detect unit 12. The transmission control unit 14 automatically determines whether to transmit the position-relative data signal to the coder 16 or the first wired connector 18 according to if the first wired connector 18 is connected. If the first wired connector 18 is not connected, the transmission control unit 14 direct transmits the position-relative data signal to the coder 16 to be coded; otherwise the transmission control unit 14 transforms the position-relative data signal to the corresponding format and sends it to the computer through the first wired connector 18.

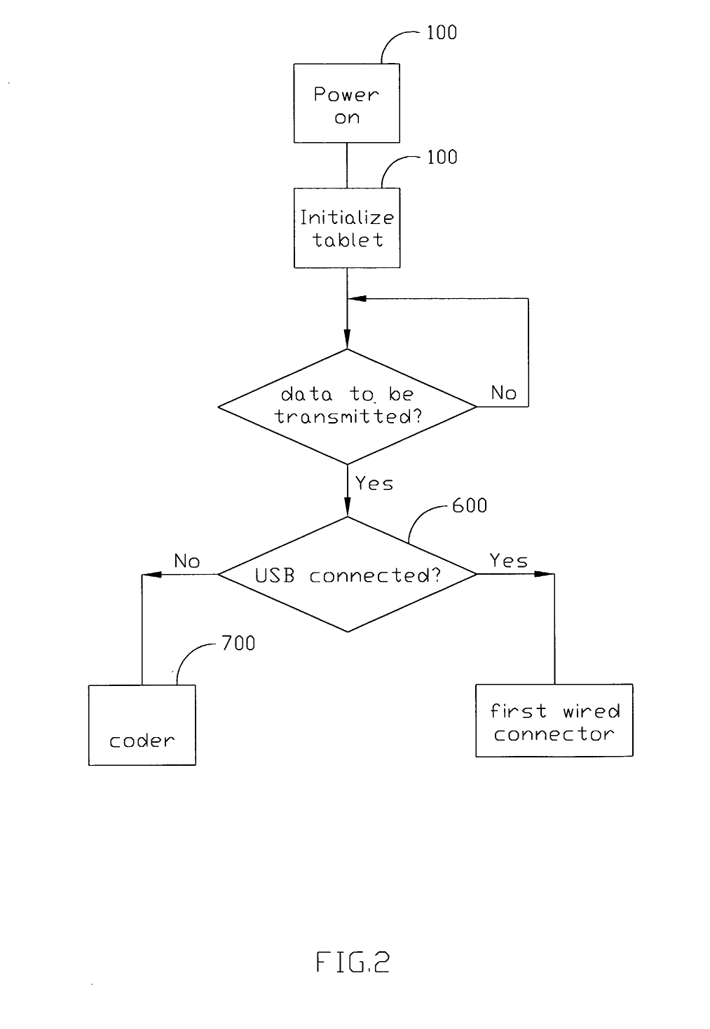

The first wired connector 18 described above corresponds to the specification of Universal Serial Bus (USB), and the transmission control unit 14 detects whether the first wired connector 18 is connected using a well-known art. FIG. 2 shows the flow chart of the well-known art. As the digital tablet being actuated, the position detect unit 12 initializes various parameters, and runs into a detect loop. According to the well-known art, when the USB port on the computer 20 is connected, the computer 20 sends an interrupt signal to the device connected to the other end of the USB for notification of starting transmission. Hence in the detect loop the transmission control unit 14 decides to transmit the position-relative data signal to the coder 16 or the first wired connector 18 according to whether the computer 20 sends an interrupt signal and whether a data signal is to be transmitted. If the wireless digital tablet transmits the data signal to the computer 20 through the first wired connector 18, the transmission control unit 14 switches the tablet to be powered by the computer 20 using a power supply pin contained in the USB, and therefore saves the consumption of the battery power of the tablet.

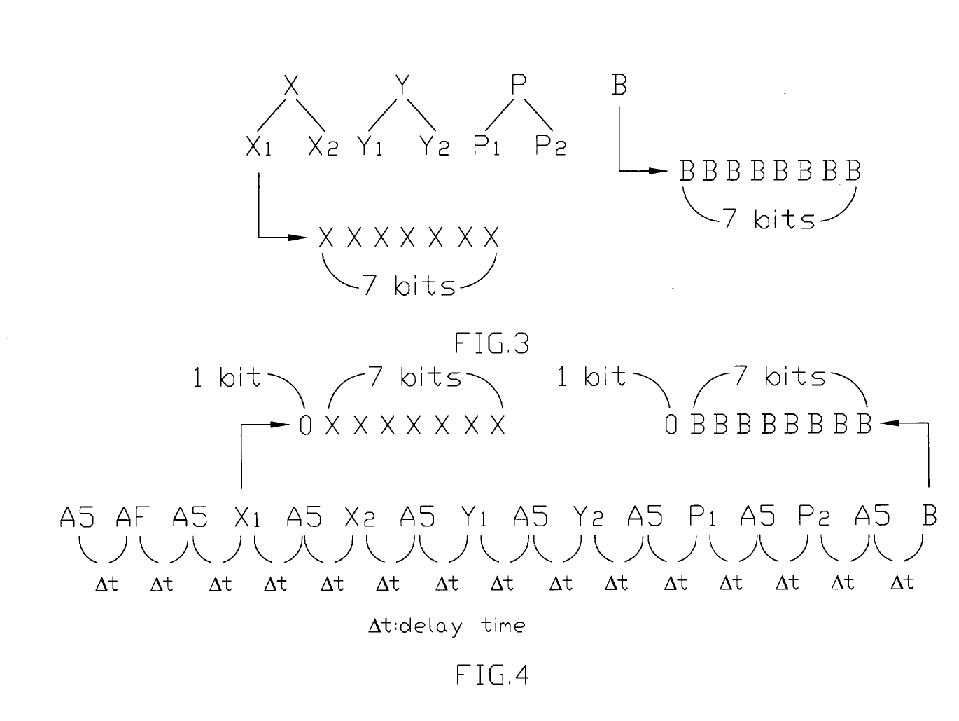

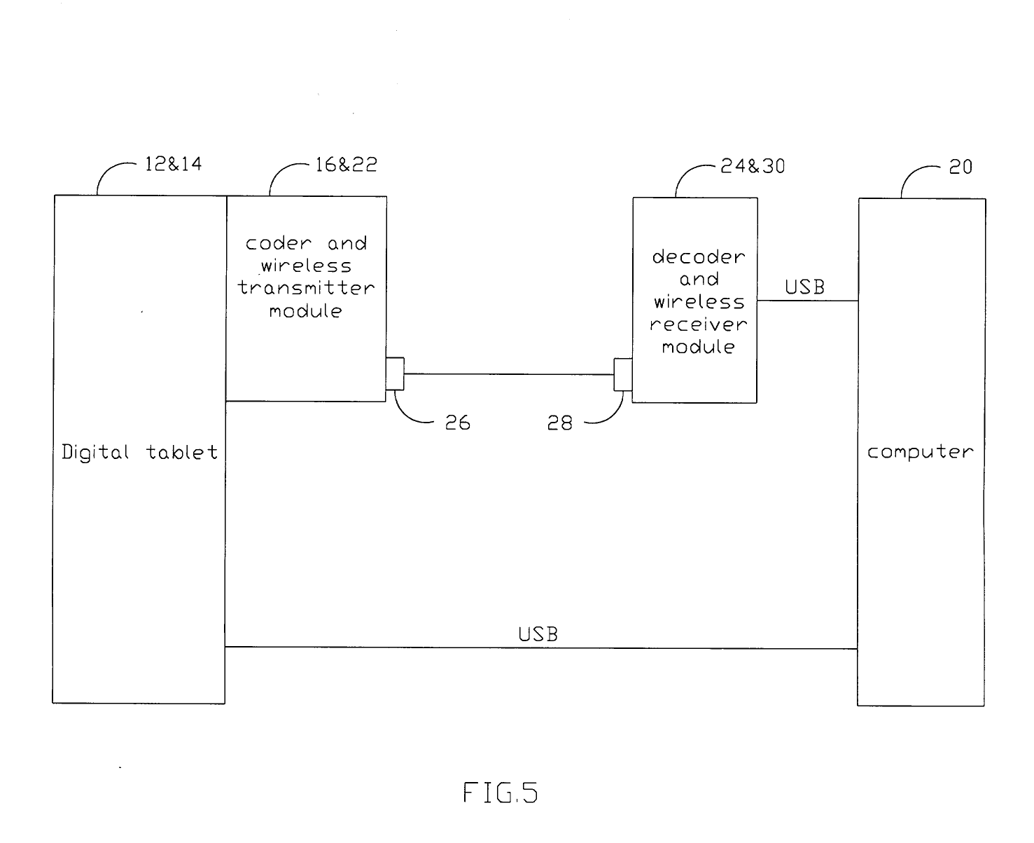

If the first wired connector 18 is not connected, the transmission control unit 14 transmits the position-relative data signal to the coder 16 to be coded. FIG. 3 shows the position-relative data signal before coding, and FIG. 4 shows how the coder 16 codes the position-relative data signal, wherein X, Y, P, B represent the X-coordinate data signal, Y-coordinate data signal, pressure signal, and button signal respectively. X, Y, P comprise two bytes respectively, while B comprising only one byte, and each byte contains 7 bits of data signal. The coder 16 adds a byte of header code AF to the head of the position-relative data signal, and codes the first bit of each byte of X, Y, P, B to O, thus each byte of X, Y, P, B comprises a first bit coded O and following 7 bits of data signal. The coded position-relative data signal is transmitted to the wireless transmitter module 22 shown in FIG. 1, where a byte of synchronous signal A5 is added ahead of each byte of the coded position-relative data signal, resulting in total 16 bytes in the final position-relative data signal; the wireless transmitter module 22 further adds a delay time between each byte of the position-relative data signal, and finally another delay time between adjacent position-relative data signals. The wireless transmitter module 22 and the wireless receiver module 24 shown in FIG. 1 correspond to the specification of RF or Blue Tooth format, and transmit the coded position-relative data signal using carrier modulation. As shown in FIG. 1, the wireless digital tablet further comprises a second wired connector 26 and a third wired connector 28, the second wired connector 26 receiving the coded position-relative data signal from the coder while the third wired connector connecting with the second wired connector and sending the position-relative data signal to the computer through the wireless receiver module 24, and the decoder 30, such that when the first wired connector 18 is not connected and the second wired connector 26 and the third wired connector 28 are connected, the transmission control unit 14 determines automatically to transmit the coded position-relative data signal to the computer 20 through the second wired connector 26, the third wired connector 28, and the decoder 30. The second wired connector 26 and the third wired connector 28 further comprise a power supply pin, such that when the second wired connector 26 and the third wired connector 28 are connected, the transmission control unit 14 switches the tablet to be powered by the computer 20, and therefore saves the consumption of the battery power of the tablet. Accordingly the priority of the transmission modes in the preferred embodiment is as follows: if the first wired connector 18 is connected, then the position-relative data signal is transmitted to the computer 20 through the first wired connector 18; else if the second wired connector 26 and the third wired connector 28 are connected, the position-relative data signal is sent to the coder 16 and the wireless transmitter module 22 to be coded and then transmitted to the computer 20 through the second wired connector 26 and the third wired connector 28; else the position-relative data signal is sent to the coder 16 and the wireless transmitter module 22 to be coded and then wirelessly transmitted to the computer 20. By way of the principle of the preferred embodiment, users may choose whether to use a wired connector to save the consumption of the battery power of the tablet.

FIG. 5 shows a concrete structure of the former preferred embodiment. Another preferred embodiment of the wireless digital tablet with multiple transmission modes provided in the present invention may be practiced in a similar way as the former embodiment except that the first wired connector 18 is replaced with one corresponding to the specification of RS232. Because the power supplied by the RS232 pin is low, the first wired connector 18 herein has to come with an external power supply to maintain the tablet working. Similarly, the transmission control unit 14 switches the tablet to be powered by the external power supply, and therefore saves the consumption of the battery power of the tablet. In addition to USB and RS232, the first wired connector 18 may further be replaced with any other wired data transmission interface, for example, IEEE 1394 interface, as long as the wired data transmission interface contains a power supply pin or be equipped with an external power supply.

Although the invention has been described and illustrated in detail as the preferred embodiments, it is to be clearly understood that the same is by way of illustration and example, and is not to be taken by way of limitation, and accordingly all variations and modifications in light of the spirit of the present invention are included within the scope of the following claims.

1. A digital tablet with multiple transmission modes, comprising:
a position detect unit detecting the position of the induction pen and producing a position-relative data signal;
a transmission control unit controlling the mode of transmission and transmitting said position-relative data signal to a computer;
a first wired connector, with its first end connecting with said transmission control unit to receive said position-relative data signal from and transmitting said position-relative data signal to said computer through its second end;
a coder, receiving and coding said position-relative data signal;
a wireless transmitter module, transmitting wirelessly said coded position-relative data signal;
a wireless receiver module, receiving said wirelessly transmitted position-relative data signal; and
a decoder, decoding said received position-relative data signal and transmitting it to said computer.

2. The digital tablet with multiple transmission modes as set forth in claim 1, wherein said position detect unit comprising:
an antenna loop, inducing said induction pen and producing an induced signal;
a transform circuit, transforming said induced signal to a corresponding digital signal; and
a process circuit, processing said digital signal to obtain the position of said induction pen.

3. The digital tablet with multiple transmission modes as set forth in claim 1, wherein said position-relative data signal comprising:
X-coordinate data signal, representing the position in X coordinate of said induction pen;
Y-coordinate data signal, representing the position in Y coordinate of said induction pen;
pressure signal, indicating the pressure from the tip of said induction pen; and
button signal, indicating the status of the buttons on said induction pen.

4. The digital tablet with multiple transmission modes as set forth in claim 1, wherein said coder adding a header to the head of each said position-relative data signal.

5. The digital tablet with multiple transmission modes as set forth in claim 4, wherein said coder coding the first bit of each byte of said position-relative data signal.

6. The digital tablet with multiple transmission modes as set forth in claim 1, wherein said wireless transmitter module adding at least a synchronous signal to said coded position-relative data signal.

7. The digital tablet with multiple transmission modes as set forth in claim 6, wherein said wireless transmitter module further adding a delay time between each byte of said position-relative data signal.

8. The digital tablet with multiple transmission modes as set forth in claim 7, wherein said wireless transmitter module further adding another delay time between adjacent said position-relative data signals.

9. The digital tablet with multiple transmission modes as set forth in claim 1 performing the following steps while said first wired connector connected with said transmission control unit and said computer:
said computer sending an interrupt signal to notify said transmission control unit for data transmission; and
said transmission control unit receiving said interrupt signal and said position detect unit processing said position-relative data signal to the corresponding format.

10. The digital tablet with multiple transmission modes as set forth in claim 1 performing the following step while said first wired connector not connected with said transmission control unit and said computer:
said transmission control unit controlling to transmit said coded position-relative data signal to said computer through said wireless transmitter module, said wireless receiver module, and said decoder.

11. A digital tablet with multiple transmission modes, comprising:
a position detect unit detecting the position of the induction pen and producing a position-relative data signal;
a transmission control unit controlling the mode of transmission and transmitting said position-relative data signal to a computer;
a first wired connector, with its first end connected with said transmission control unit to receive said position-relative data signal from and transmitting said position-relative data signal to said computer through its second end;
a coder, receiving and coding said position-relative data signal;
a wireless transmitter module, transmitting wirelessly said coded position-relative data signal;
a second wired connector, receiving and transmitting said coded position-relative data signal;
a third wired connector, connected with said second wired connector to receive and transmit said coded position-relative data signal;
a wireless receiver module, receiving said transmitted position-relative data signal; and
a decoder, decoding said received position-relative data signal and transmitting it to said computer.

12. The digital tablet with multiple transmission modes as set forth in claim 11, wherein said position detect unit comprising:
an antenna loop, inducing said induction pen and producing an induced signal;
a transform circuit, transforming said induced signal to a corresponding digital signal; and
a process circuit, processing said digital signal to obtain the position of said induction pen.

13. The digital tablet with multiple transmission modes as set forth in claim 11, wherein said position-relative data signal comprising:
X-coordinate data signal, representing the position in X coordinate of said induction pen;
Y-coordinate data signal, representing the position in Y coordinate of said induction pen;
pressure signal, indicating the pressure from the tip of said induction pen; and
button signal, indicating the status of the buttons on said induction pen.

14. The digital tablet with multiple transmission modes as set forth in claim 11, wherein said coder adding a header to the head of each said position-relative data signal.

15. The digital tablet with multiple transmission modes as set forth in claim 14, wherein said coder coding the first bit of each byte of said position-relative data signal.

16. The digital tablet with multiple transmission modes as set forth in claim 11, wherein said wireless transmitter module adding at least a synchronous signal to said coded position-relative data signal.

17. The digital tablet with multiple transmission modes as set forth in claim 16, wherein said wireless transmitter module further adding a delay time between each byte of said position-relative data signal.

18. The digital tablet with multiple transmission modes as set forth in claim 17, wherein said wireless transmitter module further adding another delay time between adjacent said position-relative data signals.

19. The digital tablet with multiple transmission modes as set forth in claim 11, wherein said second wired connector and said third wired connector comprising a power supply pin.

20. The digital tablet with multiple transmission modes as set forth in claim 11 performing the following steps while said first wired connector connected with said transmission control unit and said computer:
said computer sending an interrupt signal to notify said transmission control unit for data transmission; and
said transmission control unit receiving said interrupt signal and said position detect unit processing said position-relative data signal to the corresponding format.

21. The digital tablet with multiple transmission modes as set forth in claim 11 performing the following step while said second wired connector connected with said third wired connector and said first wired connector not connected with said transmission control unit and said computer:
said transmission control unit controlling to transmit said coded position-relative data signal to said computer through said second wired connector, said third wired connector, and said decoder.

22. The digital tablet with multiple transmission modes as set forth in claim 11 performing the following step while said second wired connector not connected with said third wired connector and said first wired connector not connected with said transmission control unit and said computer:
said transmission control unit controlling to transmit said coded position-relative data signal to said computer through said wireless transmitter module, said wireless receiver module, and said decoder.

23. A digital tablet with multiple transmission modes, comprising:
a position detect unit detecting the position of the induction pen and producing a position-relative data signal;
a transmission control unit controlling the mode of transmission and transmitting said position-relative data signal to a computer;
a first wired connector, with its first end connected with said transmission control unit to receive said position-relative data signal and transmitting said position-relative data signal to said computer through its second end;
a coder, receiving and coding said position-relative data signal;
a second wired connector connected with said coder to receive and transmit said coded position-relative data signal;
a third wired connector connected with said second wired connector to receive and transmit said coded position-relative data signal; and
a decoder, decoding said received position-relative data signal and transmitting it to said computer.

24. The digital tablet with multiple transmission modes as set forth in claim 23, wherein said position detect unit comprising:
an antenna loop, inducing said induction pen and producing an inducing signal;
a transform circuit, transforming said induced signal to a corresponding digital signal; and
a process circuit, processing said digital signal to obtain the position of said induction pen.

25. The digital tablet with multiple transmission modes as set forth in claim 23, wherein said position-relative data signal comprising:
X-coordinate data signal, representing the position in X coordinate of said induction pen;
Y-coordinate data signal, representing the position in Y coordinate of said induction pen;
pressure signal, indicating the pressure from the tip of said induction pen; and
button signal, indicating the status of the buttons on said induction pen.

26. The digital tablet with multiple transmission modes as set forth in claim 23, wherein said coder adding a header to the head of each said position-relative data signal.

27. The digital tablet with multiple transmission modes as set forth in claim 26, wherein said coder coding the first bit of each byte of said position-relative data signal.

28. The digital tablet with multiple transmission modes as set forth in claim 23 performing the following steps while said first wired connector connected with said transmission control unit and said computer:
said computer sending an interrupt signal to notify said transmission control unit for data transmission; and
said transmission control unit receiving said interrupt signal and
said position detect unit processing said position-relative data signal to the corresponding format.

29. The digital tablet with multiple transmission modes as set forth in claim 23 performing the following step while said second wired connector connected with said third wired connector and said first wired connector not connected with said transmission control unit and said computer:
said transmission control unit controlling to transmit said coded position-relative data signal to said computer through said second wired connector, said third wired connector, and said decoder.

30. A method of digital tablets for multiple data transmission modes comprising:
detecting the position of the induction pen to produce a position-relative data signal;
transmitting said position-relative data signal to a computer at a first wired transmission mode while said first wired transmission mode being set up;
while said first wired transmission mode not being set up:
coding said position-relative data signal;
transmitting said coded position-relative data signal wirelessly;
receiving said wirelessly transmitted position-relative data signal; and
decoding said received position-relative data signal and transmitting it to said computer.

31. The method of digital tablets for multiple data transmission modes as set forth in claim 30, wherein said first wired transmission mode further comprising powering said digital tablet by said computer through said first wired transmission mode.

32. A method of digital tablets for multiple data transmission modes comprising:
detecting the position of the induction pen to produce a position-relative data signal;
transmitting said position-relative data signal to a computer at a first wired transmission mode while said first wired transmission mode being set up;
coding said position-relative data signal while said first wired transmission mode not being set up;
transmitting said position-relative data signal to said computer at a second wired transmission mode while said second wired transmission mode being set up;
transmitting wirelessly said coded position-relative data signal while said second wired transmission mode not being set up;
receiving said wirelessly transmitted position-relative data signal; and
decoding said received position-relative data signal and transmitting it to said computer.

33. The method of digital tablets for multiple data transmission modes as set forth in claim 32, wherein said first wired transmission mode further comprising powering said digital tablet by said computer through said first wired transmission mode.

34. The method of digital tablets for multiple data transmission modes as set forth in claim 32, wherein said second wired transmission mode further comprising powering said digital tablet by said computer through said second wired transmission mode.

35. A method of digital tablets for multiple data transmission modes comprising:
detecting the position of the induction pen to produce a position-relative data signal;
transmitting said position-relative data signal to a computer at a first wired transmission mode while said first wired transmission mode being set up;
coding said position-relative data signal while said first wired transmission mode not being set up;
transmitting said position-relative data signal to said computer at a second wired transmission mode while said second wired transmission mode being set up; and
decoding said transmitted position-relative data signal and transmitting it to said computer.

36. The method of digital tablets for multiple data transmission modes as set forth in claim 35, wherein said first wired transmission mode further comprising powering said digital tablet by said computer through said first wired transmission mode.

37. The method of digital tablets for multiple data transmission modes as set forth in claim 35, wherein said second wired transmission mode further comprising powering said digital tablet by said computer through said second wired transmission mode.
